(19) United States
(12) Patent Application Publication
(10) Pub. No.: US 2025/0319832 A1
(43) Pub. Date: Oct. 16, 2025

(54) VEHICULAR DIALOGUE SYSTEM

(71) Applicant: YAZAKI CORPORATION, Tokyo (JP)

(72) Inventors: Fumiya Watanabe, Susono-shi (JP); Jun Shihaku, Susono-shi (JP)

(21) Appl. No.: 19/251,648

(22) Filed: Jun. 26, 2025

Related U.S. Application Data
(63) Continuation of application No. PCT/JP2024/037261, filed on Oct. 18, 2024.

(30) Foreign Application Priority Data
Oct. 23, 2023 (JP) 2023-181856
Feb. 19, 2024 (JP) 2024-023172

(51) Int. Cl. B60R 16/037; B60K 35/10; B60K 35/26; G10L 15/22

(52) U.S. Cl. CPC B60R 16/0373; B60K 35/10; B60K 35/265; G10L 15/22

(57) ABSTRACT

A voice dialogue unit determines whether the text data converted by a voice recognition unit indicates an operation instruction for an in-vehicle device. The voice dialogue unit controls, in response to determining that the text data indicates the operation instruction for the in-vehicle device, the in-vehicle device according to the operation instruction. The voice dialogue unit inputs, in response to determining that the text data does not indicate the operation instruction for the in-vehicle device, text data of voice to a conversational AI as input information.

### CROSS-REFERENCE TO RELATED APPLICATIONS

This is a continuation of International Application No. PCT/JP2024/037261 filed on Oct. 18, 2024, and claims priority from Japanese Patent Application No. 2023-181856 filed on Oct. 23, 2023 and Japanese Patent Application No. 2024-023172 filed on Feb. 19, 2024, the entire contents of which are incorporated herein by reference.

### TECHNICAL FIELD

The present disclosure relates to a vehicular dialogue system.

### BACKGROUND ART

A voice agent service that responds by voice when a user utters has been proposed (Patent Literature 1). The voice agent service in Patent Literature 1 is a system that responds only to predefined utterance data and returns a reply. For this reason, when an utterance other than the defined utterance content is made, the voice agent service in Patent Literature 1 either responds with “I don't understand” or responds by associating the utterance with the closest utterance among the defined utterances. As a result, the service does not return a natural response like a conversation with a human.

In recent years, a conversational AI (generative AI) capable of engaging in more natural conversations by learning from vast amounts of information available on the Internet, such as ChatGPT, has been proposed. However, although this type of conversational AI is suitable for casual conversations such as small talk, it does not have a function to operate in-vehicle devices. As a result, there is a problem in that when a driver makes an utterance intending to operate a device, this type of conversational AI is unable to handle this situation.

### CITATION LIST

### Patent Literature

Patent Literature 1: JP2014-98844A

### SUMMARY OF INVENTION

The present disclosure has been made in view of the above circumstances, and an object thereof is to provide a vehicular dialogue system capable of operating an in-vehicle device by voice and further capable of making a natural response to an utterance that is not intended to operate the in-vehicle device, such as small talk.

### Solution to Problem

To achieve the above object, the vehicular dialogue system according to the present disclosure has the following features.

A vehicular dialogue system utilizing a conversational AI that, in response to receiving input information composed of text data, outputs response information composed of text data, the vehicular dialogue system including:
a voice input unit configured to input voice uttered by a driver;
a voice recognition unit configured to convert the voice input by the voice input unit into text data;
a device control unit configured to control, in response to determining that the text data converted by the voice recognition unit indicates an operation instruction for an in-vehicle device, the in-vehicle device according to the operation instruction;
a voice synthesis unit configured to convert, in response to determining that the text data does not indicate the operation instruction for the in-vehicle device, the response information output from the conversational AI into voice according to the input information composed of the text data converted by the voice recognition unit;
a voice output unit configured to output the voice converted by the voice synthesis unit; and
a second input control unit configured to input, as the input information to the conversational AI, the text data converted by the voice recognition unit, a determination command as to whether the text data indicates an operation instruction for the in-vehicle device, and a transmission command for the response information corresponding to the text data when the text data does not indicate the operation instruction.

The device control unit controls, in response to inputting, from the conversational AI, the response information that indicates the operation instruction for the in-vehicle device, the in-vehicle device according to the operation instruction, and the voice synthesis unit converts, in response to inputting, from the conversational AI, the response information that does not indicate the operation instruction for the in-vehicle device, the response information corresponding to the text data into voice.

According to the vehicular dialogue system of the present disclosure, an effect can be achieved in which an in-vehicle device can be operated by voice and further a natural response can be made to an utterance that is not intended to operate the in-vehicle device, such as small talk. Further, the conversational AI can be made to determine whether the text data indicates an operation instruction, thereby improving processing capabilities.

The present disclosure has been briefly described above. Further, the details of the present disclosure can be clarified by reading modes (hereinafter, referred to as “embodiments”) for carrying out the invention described below with reference to the accompanying drawings.

### BRIEF DESCRIPTION OF DRAWINGS

FIG. 1 is a block diagram illustrating a vehicular dialogue system according to an embodiment of the present disclosure;

FIG. 2 illustrates an example of a data table stored in a ROM illustrated in FIG. 1;

FIG. 3 is a view illustrating a periphery of an instrument panel of a vehicle equipped with the vehicular dialogue system illustrated in FIG. 1;

FIG. 4 is a flowchart illustrating a processing procedure of a microcomputer constituting a vehicular communication system illustrated in FIG. 1 in the first embodiment;

FIG. 5 is an explanatory diagram illustrating an operation in Sp5 in FIG. 4;

FIG. 6 is a flowchart illustrating a processing procedure of a microcomputer constituting a vehicular communication system illustrated in FIG. 1 according to a second embodiment;

FIG. 7 is a block diagram of a vehicular dialogue system according to another embodiment;

FIG. 8 is a block diagram of a vehicular dialogue system according to another embodiment;

FIG. 9 is a block diagram of a vehicular dialogue system according to another embodiment; and

FIG. 10 illustrates another example of the data table stored in the ROM illustrated in FIG. 1.

### DESCRIPTION OF EMBODIMENTS

### First Embodiment

A first embodiment of the present disclosure will be described below with reference to the drawings.

A vehicular dialogue system 1 according to the first embodiment is a system that is mounted on a vehicle and interacts with a driver utilizing a conversational artificial intelligence (AI) 10. The conversational AI 10 is implemented by, for example, ChatGPT, and outputs response information S2 composed of text data when input information S1 composed of text data is input.

The vehicular dialogue system 1 includes a microphone 2 as a voice input unit, a communication module 3, a microcomputer 4, a speaker 5 as a voice output unit, a display 6, and a read only memory (ROM) 7 (storage unit). The microphone 2 inputs voice uttered by the driver to the microcomputer 4. The communication module 3 is for communicating with the conversational AI 10 via an Internet communication network (not illustrated), and includes a circuit, an antenna, and the like for connecting to the Internet communication network. In the present embodiment, the communication module 3, the microcomputer 4, and a ROM 7 described later are mounted on a same control board 100.

The microcomputer 4 includes, for example, a memory such as a random access memory (RAM) or a ROM, and a central processing unit (CPU) that operates according to a program stored in the memory, and controls the entire vehicular dialogue system 1.

The microcomputer 4 includes a voice recognition unit 41, a voice dialogue unit 42, a voice synthesis unit 44, and a drawing processing unit 45. The voice recognition unit 41 converts the voice input by the microphone 2 into text data and inputs the text data to the voice dialogue unit 42. The voice dialogue unit 42 inputs the text data converted by the voice recognition unit 41 to the conversational AI 10 as input information S1.

The voice dialogue unit 42 receives vehicle information S3 and personal information S4 as input. The microcomputer 4 is connected to a sensor or a device mounted on the vehicle via a communication network provided in the vehicle, such as a controller area network (CAN). The vehicle information S3 is information indicating a state of the vehicle acquired from the sensor or the device mounted on the vehicle.

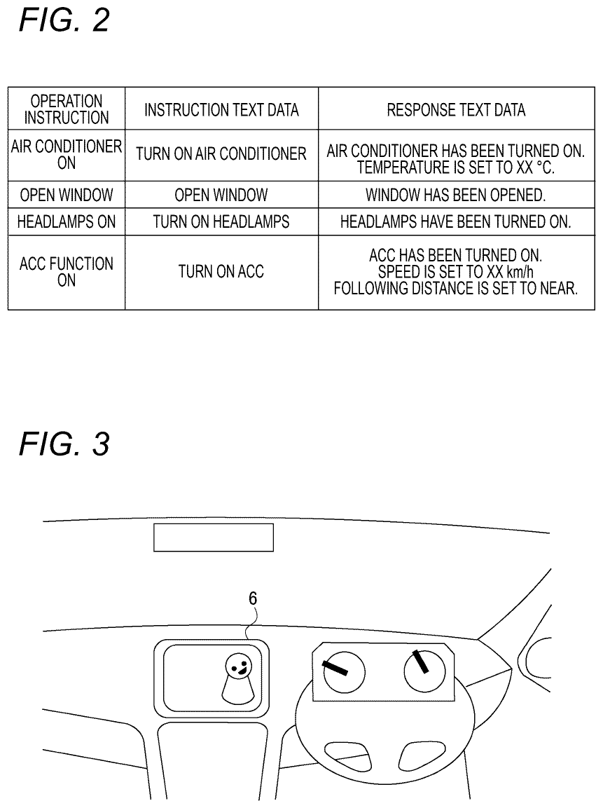

As illustrated in FIG. 2, the ROM 7 stores a data table including an operation instruction for an in-vehicle device 11, instruction text data corresponding to the operation instruction for the in-vehicle device 11, and response text data corresponding to the instruction text data. In the example illustrated in FIG. 2, one piece of instruction text data is stored for one operation instruction. However, the present disclosure is not limited thereto. A plurality of pieces of instruction text data may be stored for one operation instruction. For example, instruction text data such as “hot” and “cold” may be associated with an operation instruction of “air conditioner ON”, in addition to “turn on air conditioner”.

The personal information S4, which is a detection result from a driver monitor that detects a state of the driver (whether the driver is dozing, careless driving, or inattentive driving) based on an image obtained by photographing a face of the driver, is input to the voice dialogue unit 42.

The voice dialogue unit 42 is connected to the in-vehicle device 11 mounted on the vehicle, and can control the in-vehicle device 11. Examples of the in-vehicle device 11 include an air conditioner mounted on the vehicle, a motor that opens and closes a window, headlamps, and an electronic control unit (ECU) that controls an adaptive cruise control (ACC) function.

The voice dialogue unit 42 functions as a determination unit, compares the text data converted by the voice recognition unit 41 with the instruction text data illustrated in FIG. 2, and determines that the text data converted by the voice recognition unit 41 indicates an operation instruction for the in-vehicle device 11 when there is a match. If there is no match, the voice dialogue unit 42 determines that the text data converted by the voice recognition unit 41 does not indicate an operation instruction for the in-vehicle device 11.

If the voice dialogue unit 42 determines that the text data indicates an operation instruction for the in-vehicle device 11, the voice dialogue unit 42 functions as a device control unit and controls the in-vehicle device 11 according to the operation instruction corresponding to the compared instruction text data. If the voice dialogue unit 42 determines that the text data indicates an operation instruction for the in-vehicle device 11, the voice dialogue unit 42 inputs response text data corresponding to the matched instruction text data to the voice synthesis unit 44.

When the voice dialogue unit 42 determines that the text data does not indicate an operation instruction for the in-vehicle device 11, the voice dialogue unit 42 transmits a prompt including the text data converted by the voice recognition unit 41 to the conversational AI 10 as the input information S1. The voice dialogue unit 42 inputs the response information S2 from the conversational AI 10 and outputs the input response information S2 to the voice synthesis unit 44. The voice synthesis unit 44 converts the response text data or the response information S2 into voice and outputs the voice to the speaker 5. The speaker 5 outputs the voice converted by the voice synthesis unit 44.

The voice dialogue unit 42 outputs a display request for displaying a character on the display 6 to the drawing processing unit 45 while the voice is being output from the speaker 5. As illustrated in FIG. 3, the display 6 is disposed on an instrument panel between a driver seat and a passenger seat. The drawing processing unit 45 outputs to the display 6 an image in which the character appears to be speaking in synchronization with the voice output from the speaker 5.

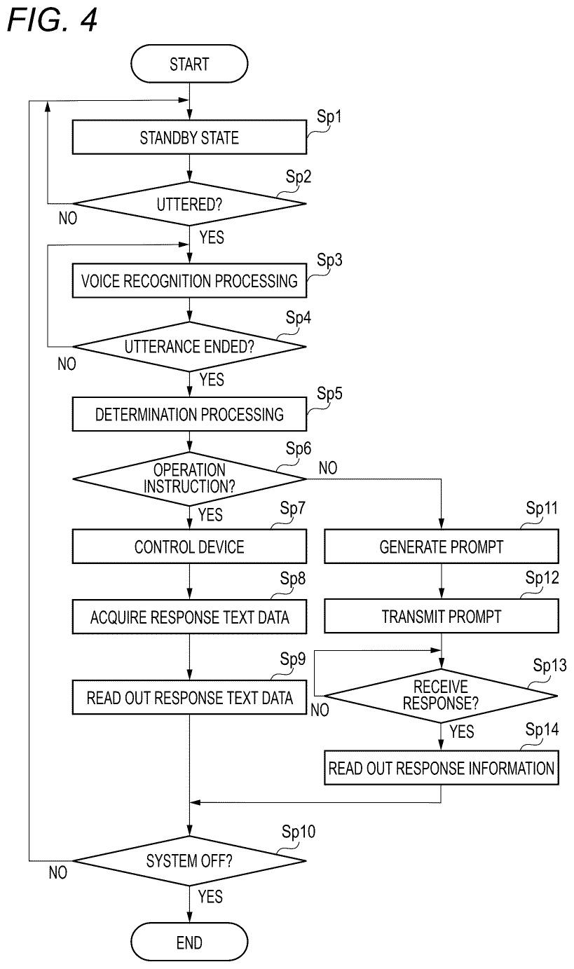

Next, an operation of the vehicular dialogue system 1 having the above configuration will be described with reference to a flowchart illustrated in FIG. 4. If the microcomputer 4 detects that the vehicular dialogue system 1 is turned on, such as when the ignition is turned on, the microcomputer 4 starts the processing illustrated in FIG. 4. First, the microcomputer 4 enters a standby state until the driver starts to utter (Sp1). If the driver utters (Y in Sp2), the microcomputer 4 performs voice recognition processing of converting the voice uttered by the driver into text data (Sp3).

If the utterance has not ended (N in Sp4), the processing returns to Sp3, and the microcomputer 4 continues the voice recognition processing. On the other hand, if the utterance ends (Y in Sp4), the microcomputer 4 performs determination processing of determining whether the text data of the voice converted by the voice recognition processing indicates an operation instruction for the in-vehicle device 11 (Sp5).

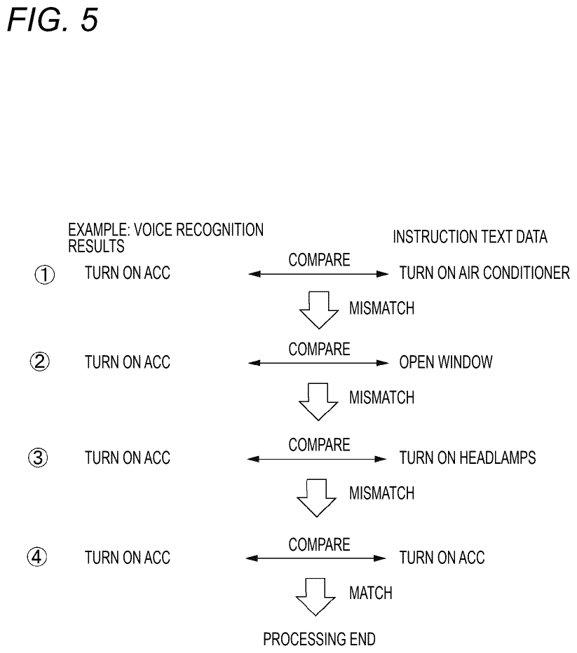

In the determination processing, the microcomputer 4 compares the text data of the voice with a plurality of pieces of instruction text data illustrated in FIG. 2 one by one. For example, when the text data of the voice is “turn ON ACC”, the microcomputer 4 sequentially compares the text data with the instruction text data “turn on air conditioner”, “open window”, “turn on headlamps”, and “turn ON ACC”, as illustrated in FIG. 5.

If there is instruction text data that matches the text data of the voice, the microcomputer 4 determines that the text data of the voice indicates an operation instruction for the in-vehicle device 11. The microcomputer 4 is not limited to determining a match based on complete matching of the text data, and may determine a match when a match rate of words is equal to or greater than a certain value.

Next, if the microcomputer 4 determines through the determination processing that the text data of the voice indicates an operation instruction for the in-vehicle device 11 (Y in Sp6), the microcomputer 4 controls the in-vehicle device 11 according to the operation instruction corresponding to the matched instruction text data (Sp7). For example, when the text data of the voice matches the instruction text data “turn on the ACC function” in the determination processing, the microcomputer 4 transmits a request to turn on the ACC function to the ECU that controls the ACC function according to the operation instruction.

Next, the microcomputer 4 acquires response text data corresponding to the matched instruction text data from the data table (Sp8). Next, the microcomputer 4 performs a voice synthesis processing of converting the acquired response text data into voice and outputting the voice from the speaker 5, and after the response text data is read out (Sp9), the processing proceeds to Sp10. For example, in the determination processing, when the text data of the voice matches the instruction text data “turn on the ACC function”, in Sp8, the microcomputer 4 acquires response text data “The ACC has been turned on. Speed is set to xx km/h. Following distance is set to near”, and the response text data is read out from the speaker 5.

On the other hand, if the microcomputer 4 determines through the determination processing that the text data of the voice does not indicate an operation instruction for the in-vehicle device 11 (N in Sp6), the microcomputer 4 creates a prompt including the text data of the voice (Sp11). In Sp11, the microcomputer 4 may create only the text data of the voice as the prompt, or may create a prompt in which text data corresponding to the vehicle information

S3 or the personal information S4 is added to the text data of the voice.

Next, the microcomputer 4 functions as a first input control unit and transmits the created prompt to the conversational AI 10 as the input information S1 (Sp12). If the microcomputer 4 receives the response information S2 from the conversational AI 10 (Y in Sp13), the microcomputer 4 converts the received response information S2 into voice and outputs the voice from the speaker 5, and after the response information S2 is read out (Sp14), the processing proceeds to Sp10.

In Sp10, if the microcomputer 4 detects that the vehicular dialogue system 1 is turned off, such as when the ignition is turned off, (Y in Sp10), the processing ends. If the microcomputer 4 does not detect that the vehicular dialogue system 1 is turned off (N in Sp10), the processing returns to Sp1, and the microcomputer 4 enters the standby state until the driver utters again.

According to the above embodiment, the microcomputer 4 determines whether the text data of the voice indicates an operation instruction for the in-vehicle device 11, and if the microcomputer 4 determines that the text data of the voice indicates an operation instruction for the in-vehicle device 11, the microcomputer 4 controls the in-vehicle device 11 according to the operation instruction. Further, if the microcomputer 4 determines that the text data of the voice does not indicate the operation instruction for the in-vehicle device 11, the microcomputer 4 transmits a prompt including the text data of the voice to the conversational AI 10. Accordingly, the vehicular dialogue system 1 can operate the in-vehicle device 11 by voice, and can make a natural response to an utterance that is not intended to operate the in-vehicle device 11, such as small talk.

According to the above embodiment, the instruction text data is stored in the ROM 7. The microcomputer 4 compares the instruction text data with the text data of the voice, and determines whether the text data of the voice indicates an operation instruction for the in-vehicle device 11 based on whether there is matching instruction text data. Accordingly, the microcomputer 4 can easily determine whether the text data of the voice indicates an operation instruction for the in-vehicle device 11.

According to the above embodiment, the response text data is stored in the ROM 7. If the microcomputer 4 determines that the text data of the voice indicates an operation instruction for the in-vehicle device 11, the microcomputer 4 converts the response text data corresponding to the matched instruction text data into voice and reads out the voice. Accordingly, when the driver issues an operation instruction for the in-vehicle device 11, an appropriate response can be made.

### Second Embodiment

Next, a second embodiment will be described.

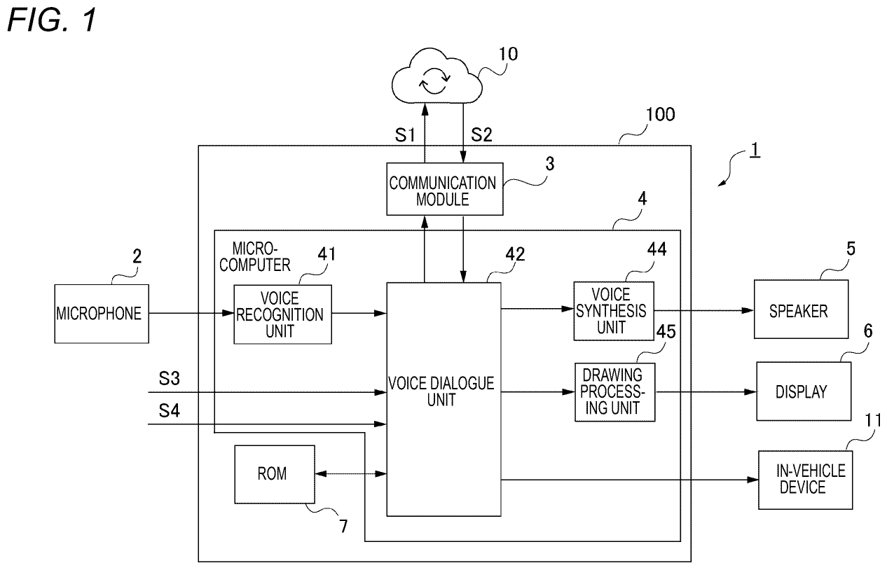

Since a vehicular dialogue system 1 according to the second embodiment has the same configuration as the vehicular dialogue system 1 according to the first embodiment illustrated in FIG. 1, detailed description thereof will be omitted here. In the first embodiment, the voice dialogue unit 42 functions as a determination unit. However, in the second embodiment, the conversational AI 10 functions as a determination unit.

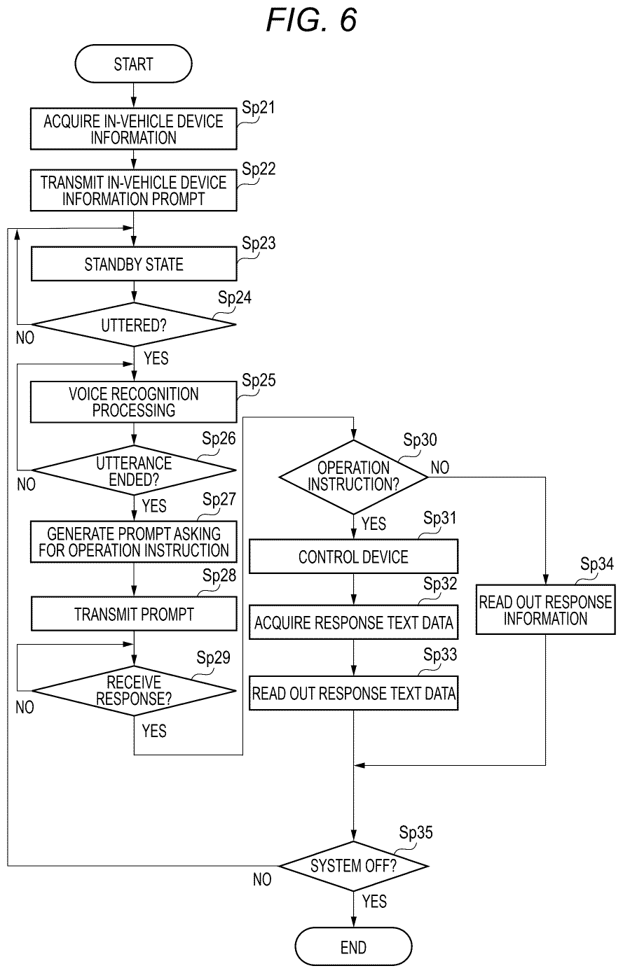

Next, an operation of the vehicular dialogue system 1 according to the second embodiment will be described with reference to a flowchart illustrated in FIG. 6. If the microcomputer 4 detects that the vehicular dialogue system 1 is turned on, such as when the ignition is turned on, the microcomputer 4 starts the processing illustrated in FIG. 6. First, the microcomputer 4 acquires information on the in-vehicle device mounted on the vehicle (in-vehicle device information) from the vehicle information S3 acquired from a controller area network (CAN) or the like (Sp21). Next, the microcomputer 4 generates a prompt to notify the conversational AI 10 of the acquired in-vehicle device information and transmits the prompt (Sp22).

An example of the prompt transmitted in the Sp22 will be described. The microcomputer 4 converts the acquired in-vehicle device information into text data. Thereafter, the microcomputer 4 generates a prompt to which the text data of the in-vehicle device information, converted between, for example, a first template sentence, “You are currently in a car.” and a second template sentence, “The vehicle is equipped with functions. Please answer the following questions based on this content.” is added. Accordingly, text data “You are currently in a car. The vehicle is equipped with functions such as ACC, wipers, headlamps, air conditioning/heater. . . . Please answer the following questions based on this content.” is transmitted to the conversational AI 10.

Thereafter, the microcomputer 4 enters a standby state until the driver starts to utter (Sp23). If the driver utters (Y in Sp24), the microcomputer 4 performs voice recognition processing of converting the voice uttered by the driver into text data (Sp25).

If the utterance has not ended (N in Sp26), the processing returns to Sp25, and the microcomputer 4 continues the voice recognition processing. On the other hand, if the utterance ends (Y in Sp26), the microcomputer 4 functions as a second input control unit, generates a prompt including the text data of the voice converted by the voice recognition processing, a determination command as to whether the text data indicates an operation instruction for the in-vehicle device 11, and a transmission command for response information corresponding to the text data when the text data does not indicate the operation instruction (Sp27), and transmits the generated prompt (Sp28).

An example of the prompt transmitted in the Sp28 will be described. The microcomputer 4 generates a prompt to which, after the text data of the voice, text data of a template sentence, “Is this content intended for operation? If it is for operation, please answer with ‘A’. Otherwise, please respond in a manner that allows the conversation to continue, but do not respond with ‘No’” is added, and transmits the prompt.

In response to receiving the response information S2 from the conversational AI 10 (Y in Sp29), the microcomputer 4 determines whether the text data of the voice indicates an operation instruction based on the response information S2 (Sp30). For example, when the microcomputer 4 transmits, in Sp28, a prompt indicating “‘Turn ON wipers.’ Is this content intended for operation? If it is for operation, please answer with ‘A’. Otherwise, please respond in a manner that allows the conversation to continue, but do not respond with ‘No’”, and in response to this, receives the response information S2 indicating “A”, the microcomputer 4 determines that the text data of the voice is an operation instruction (Y in Sp30).

If the microcomputer 4 determines that the text data of the voice is an operation instruction (Y in Sp30), the microcomputer 4 compares the text data converted by the voice recognition unit 41 with the instruction text data illustrated in FIG. 2, and controls the in-vehicle device 11 according to the operation instruction corresponding to the matching instruction text data (Sp31). Next, the microcomputer 4 acquires response text data corresponding to the matched instruction text data from the data table in FIG. 2 (Sp32). The microcomputer 4 performs voice synthesis processing of converting the acquired response text data into voice and outputting the voice from the speaker 5, and after the response text data is read out (Sp33), the processing proceeds to Sp35.

For example, when the microcomputer 4 transmits, in Sp28, a prompt indicating “‘Hello.’ Is this content intended for operation? If it is for operation, please answer with ‘A’. Otherwise, please respond in a manner that allows the conversation to continue, but do not respond with ‘No’”, and in response to this, receives response information S2 indicating “Hello. I am happy to talk with you. Is there anything you would like to ask or anything I can help with?”, the microcomputer 4 determines that the text data of the voice is not an operation instruction (N in Sp30).

If the microcomputer 4 determines that the text data of the voice is not an operation instruction, the microcomputer 4 converts the received response information S2 into voice and outputs the voice from the speaker 5, and after the response information S2 is read out (Sp34), the processing proceeds to Sp35.

In Sp35, if the microcomputer 4 detects that the vehicular dialogue system 1 is turned off, such as when the ignition is turned off, (Y in Sp35), the processing ends. If the microcomputer 4 does not detect that the vehicular dialogue system 1 is turned off (N in Sp35), the processing returns to Sp23, and the microcomputer 4 enters the standby state until the driver utters again.

According to the above embodiment, the conversational AI 10 functions as the determination unit. In the case of the first embodiment, there is a need to compare the text data uttered by the driver with each piece of the instruction text data in the data table illustrated in FIG. 2, regardless of whether the text data is an operation instruction or not. On the other hand, according to the second embodiment, when the text data uttered by the driver is not intended for the operation, there is no need to compare the text data with the instruction text data in the data table illustrated in FIG. 2, thereby improving a processing speed and improving a response speed of an answer to the utterance of the driver.

The present disclosure is not limited to the above embodiments, and can be appropriately modified, improved, or the like. In addition, materials, shapes, sizes, numbers, arrangement positions, and the like of components in the above embodiments are freely selected and are not limited as long as the present disclosure can be implemented.

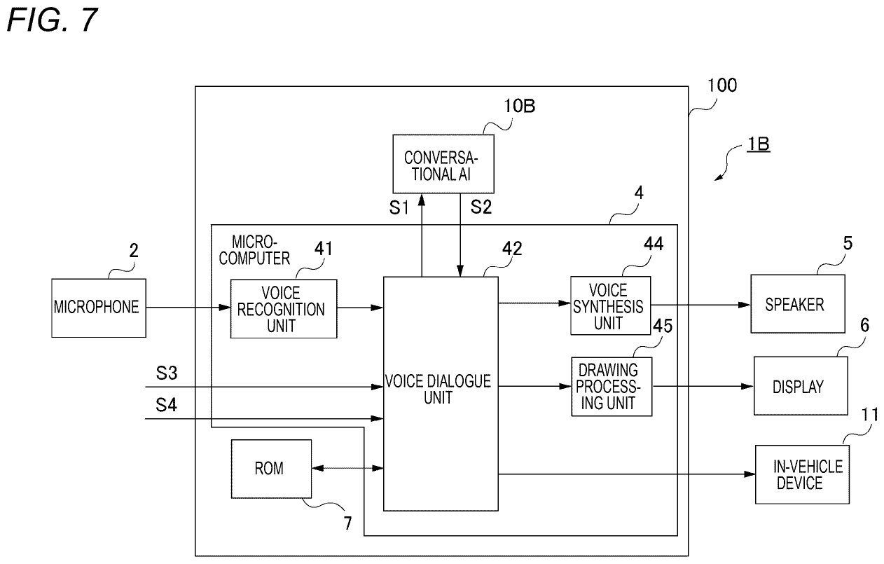

According to the above embodiments, according to the vehicular dialogue system 1 illustrated in FIG. 1, the conversational AI 10 communicates with the vehicular dialogue system 1 via the Internet communication network. However, the present disclosure is not limited thereto. As in a vehicular dialogue system 1B illustrated in FIG. 7, a conversational AI 10B including a microcomputer may be mounted on the control board 100. According to the vehicular dialogue system 1B illustrated in FIG. 7, dialogue can be carried out even in a poor communication environment.

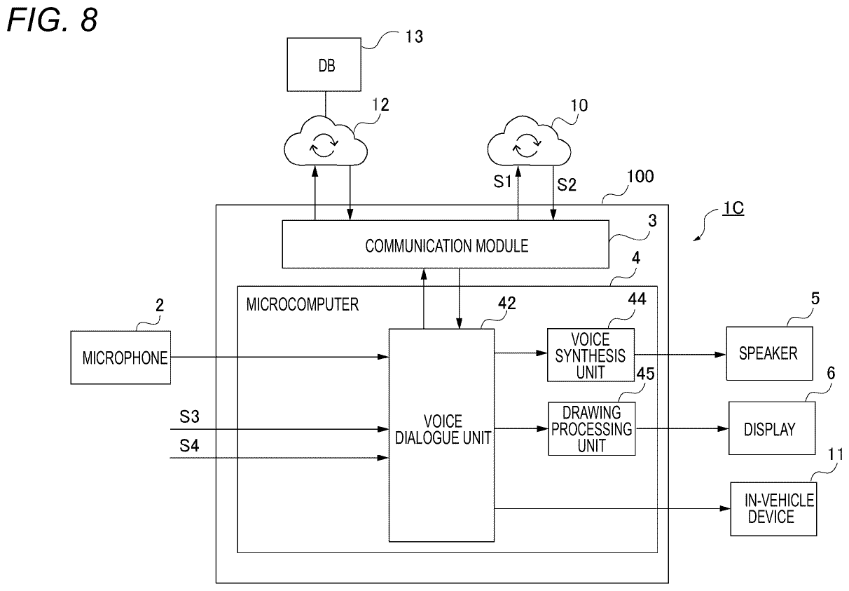

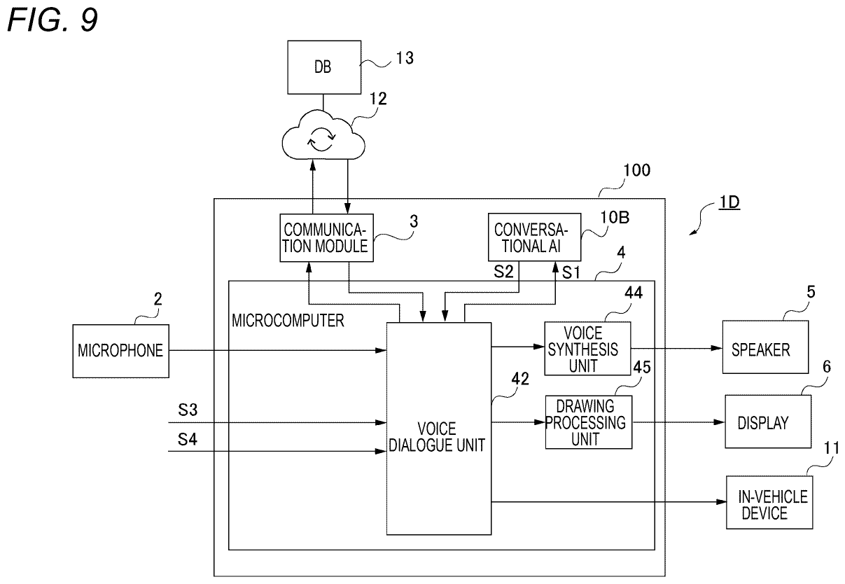

According to the vehicular dialogue system 1, 1B illustrated in FIGS. 1 and 7, the microcomputer 4 functions as the voice recognition unit. However, the present disclosure is not limited thereto. As in vehicular dialogue systems 1C and 1D illustrated in FIGS. 8 and 9, the microcomputer 4 may communicate with a server 12 that functions as a voice recognition unit and a determination unit. The server 12 can access a database (DB) 13 in which the data table illustrated in FIG. 2 is stored.

In this case, the microcomputer 4 transmits the voice input from the microphone 2 to the server 12. The server 12 converts the received voice into text data, refers to the data table stored in the DB 13, and determines whether the text data indicates an operation instruction for the in-vehicle device 11. The server 12 transmits a determination result and the text data of the voice to the microcomputer 4. Accordingly, there is no need to provide the microcomputer 4 with determination functions of the voice recognition unit 41 and the voice dialogue unit 42, and processing load can be reduced.

According to the vehicular dialogue systems 1C and 1D illustrated in FIGS. 8 and 9, the microcomputer 4 does not include the voice recognition unit 41. However, the microcomputer 4 may include the voice recognition unit 41. In this case, the microcomputer 4 converts a part of the voice into text data by the voice recognition unit 41, and converts the rest of the voice into text data by the server 12. Also in this case, the processing load of the microcomputer 4 can be reduced as compared with a case in which all voice recognitions are executed by the microcomputer 4.

According to the above first and second embodiments, the microcomputer 4 compares the text data of the voice with the plurality of pieces of instruction text data illustrated in FIG. 2 one by one, and determines whether the text data of the voice is intended for operation, and if it is intended for operation, the microcomputer 4 determines instruction content thereof. However, the present disclosure is not limited thereto.

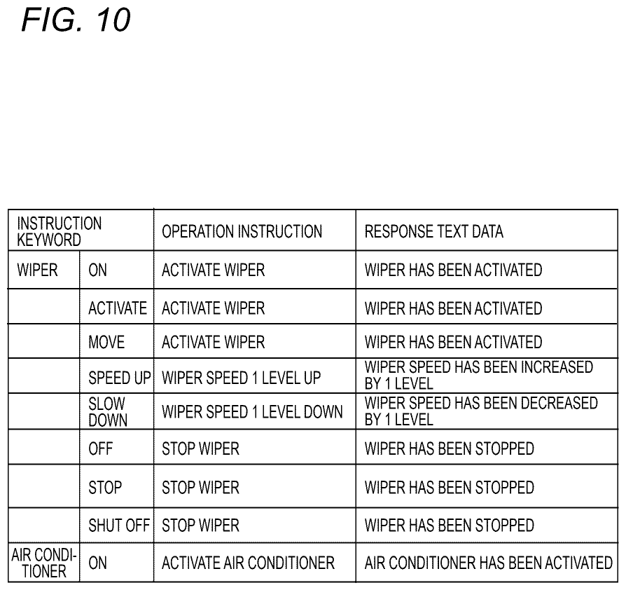

As illustrated in FIG. 10, the ROM 7 stores a data table including an operation instruction for the in-vehicle device 11, an instruction keyword corresponding to the operation instruction for the in-vehicle device 11, and response text data corresponding to the instruction keyword. The microcomputer 4 extracts a keyword from the text data of the voice, compares the extracted keyword with the instruction keyword, and if all the keywords match, the microcomputer 4 determines that it is intended for operation, and executes the operation instruction corresponding to the matching instruction keyword.

Here, features of the embodiments of the vehicular dialogue system according to the present disclosure described above are briefly summarized and listed in the following [1] to [5].

[1] A vehicular dialogue system (1, 1B, 1C, 1D) utilizing a conversational AI (10) that, in response to receiving input information (S1) composed of text data, outputs response information (S2) composed of text data, the vehicular dialogue system (1, 1B, 1C, 1D) including:
a voice input unit (2) configured to input voice uttered by a driver;
a voice recognition unit (12) configured to convert the voice input by the voice input unit (2) into text data;
a device control unit (42) configured to control, in response to determining that the text data converted by the voice recognition unit (12) indicates an operation instruction for an in-vehicle device (11), the in-vehicle device (11) according to the operation instruction;
a voice synthesis unit (44) configured to convert, in response to determining that the text data does not indicate the operation instruction for the in-vehicle device (11), the response information (S2) output from the conversational AI (10) into voice according to the input information (S1) composed of the text data converted by the voice recognition unit (12);
a voice output unit (5) configured to output the voice converted by the voice synthesis unit (44); and
a second input control unit (42) configured to input, as the input information (S1) to the conversational AI (10), the text data converted by the voice recognition unit (12), a determination command as to whether the text data indicates an operation instruction for the in-vehicle device (11), and a transmission command for the response information (S2) corresponding to the text data when the text data does not indicate the operation instruction, in which
   the device control unit (42) controls, in response to inputting, from the conversational AI (10), the response information (S2) that indicates the operation instruction for the in-vehicle device (11), the in-vehicle device (11) according to the operation instruction, and
   the voice synthesis unit (44) converts, in response to inputting, from the conversational AI (10), the response information (S2) that does not indicate the operation instruction for the in-vehicle device (11), the response information (S2) corresponding to the text data into voice.

According to the vehicular dialogue system (1, 1B, 1C, 1D) having the configuration in the above [1], the in-vehicle device (11) can be operated by voice, and further, a natural response can be made to an utterance that is not intended to operate the in-vehicle device (11), such as small talk. Further, the conversational AI (10) can be made to determine whether the text data indicates an operation instruction, thereby improving processing capabilities.

[2] The vehicular dialogue system (1, 1B, 1C, 1D) according to [1], further including:
a determination unit (42, 12) configured to determine whether the text data converted by the voice recognition unit (12) indicates an operation instruction for the in-vehicle device (11); and
a first input control unit (42) configured to input, in response to the determination unit (42, 12) determining that the text data does not indicate the operation instruction for the in-vehicle device (11), the text data converted by the voice recognition unit (12) to the conversational AI (10) as the input information (S1).

According to the vehicular dialogue system (1, 1B, 1C, 1D) having the configuration in the above [2], the text data that does not indicate the operation instruction can be input to the conversational AI (10) by the determination unit (42, 12).

[3] The vehicular dialogue system (1, 1B, 1C, 1D) according to [2], further including:
a storage unit (7, 13) configured to store instruction text data corresponding to an operation instruction for the in-vehicle device (11), in which
the determination unit (42, 12) compares the instruction text data stored in the storage unit with the text data converted by the voice recognition unit (12), and performs a determination based on whether there is matching instruction text data.

According to the vehicular dialogue system (1, 1B, 1C, 1D) having the configuration in the above [3], the determination unit (42, 12) can easily determine whether the text data of the voice indicates the operation instruction for the in-vehicle device (11).

[4] The vehicular dialogue system (1, 1B, 1C, 1D) according to [3], in which the storage unit (7, 13) further stores response text data corresponding to the instruction text data,
when the determination unit (42, 12) determines that the text data indicates an operation instruction for the in-vehicle device (11), the determination unit (42, 12) causes the voice synthesis unit (44) to convert the response text data corresponding to the matched instruction text data into the voice.

According to the vehicular dialogue system (1, 1B, 1C, 1D) having the configuration in the above [4], when a driver issues an operation instruction to the in-vehicle device (11), an appropriate response can be made.

Although the present disclosure is described in detail and with reference to the specific embodiments, it is apparent to those skilled in the art that various changes and modifications can be made without departing from the spirit and scope of the present disclosure.

The present application is based on a Japanese patent application filed on Oct. 23, 2023 (Japanese Patent Application No. 2023-181856) and a Japanese patent application filed on Feb. 19, 2024 (Japanese Patent Application No. 2024-023172), and the contents thereof are incorporated herein by reference.

### INDUSTRIAL APPLICABILITY

According to the present disclosure, a vehicular dialogue system capable of operating an in-vehicle device by voice and further capable of making a natural response to an utterance that is not intended to operate the in-vehicle device, such as small talk can be provided. The present disclosure having this effect is useful for a vehicular dialogue system.

What is claimed is:

1. A vehicular dialogue system utilizing a conversational AI that, in response to receiving input information composed of text data, outputs response information composed of text data, the vehicular dialogue system comprising:
a voice input unit configured to input voice uttered by a driver;
a voice recognition unit configured to convert the voice input by the voice input unit into text data;
a device control unit configured to control, in response to determining that the text data converted by the voice recognition unit indicates an operation instruction for an in-vehicle device, the in-vehicle device according to the operation instruction;
a voice synthesis unit configured to convert, in response to determining that the text data does not indicate the operation instruction for the in-vehicle device, the response information output from the conversational AI into voice according to the input information composed of the text data converted by the voice recognition unit;
a voice output unit configured to output the voice converted by the voice synthesis unit; and
a second input control unit configured to input, as the input information to the conversational AI, the text data converted by the voice recognition unit, a determination command as to whether the text data indicates an operation instruction for the in-vehicle device, and a transmission command for the response information corresponding to the text data when the text data does not indicate the operation instruction, wherein
the device control unit controls, in response to inputting, from the conversational AI, the response information that indicates the operation instruction for the in-vehicle device, the in-vehicle device according to the operation instruction, and
the voice synthesis unit converts, in response to inputting, from the conversational AI, the response information that does not indicate the operation instruction for the in-vehicle device, the response information corresponding to the text data into voice.

2. The vehicular dialogue system according to claim 1, further comprising:
a determination unit configured to determine whether the text data converted by the voice recognition unit indicates an operation instruction for the in-vehicle device; and
a first input control unit configured to input, in response to the determination unit determining that the text data does not indicate the operation instruction for the in-vehicle device, the text data converted by the voice recognition unit to the conversational AI as the input information.

3. The vehicular dialogue system according to claim 2, further comprising:
a storage unit configured to store instruction text data corresponding to an operation instruction for the in-vehicle device, wherein
the determination unit compares the instruction text data stored in the storage unit with the text data converted by the voice recognition unit, and performs a determination based on whether there is matching instruction text data.

4. The vehicular dialogue system according to claim 3, wherein
the storage unit further stores response text data corresponding to the instruction text data,
when the determination unit determines that the text data indicates an operation instruction for the in-vehicle device, the determination unit causes the voice synthesis unit to convert the response text data corresponding to the matched instruction text data into the voice.
